(19) United States
(12) Patent Application Publication
(10) Pub. No.: US 2013/0019380 A1
(43) Pub. Date: Jan. 24, 2013

(54) ARTICLE OF MANUFACTURE HAVING THREE-DIMENSIONAL OBJECT REMOVABLY MOUNTED THEREON

(71) Applicants: Eli SITT, Brooklyn, NY (US); Isaac SUTTON, Brooklyn, NY (US)

(72) Inventors: Eli SITT, Brooklyn, NY (US); Isaac SUTTON, Brooklyn, NY (US)

(21) Appl. No.: 13/546,199

(22) Filed: Jul. 11, 2012

Related U.S. Application Data
(60) Provisional application No. 61/572,581, filed on Jul. 19, 2011.

(51) Int. Cl. A42B 1/24; F16B 47/00; A44B 18/00; A45F 3/04; H01F 7/02; A42B 1/18; A42B 1/00; F16M 13/02; F16B 2/20

(52) U.S. Cl. 2/209.13; 248/205.1; 248/221.11; 248/205.3; 248/205.2; 248/231.81; 248/206.5; 2/175.1; 2/171; 224/627

(57) ABSTRACT

A three-dimensional object, such as a toy figurine or like accessory, is mounted and locked, with the aid of a frangible element and a tie, on an article of manufacture, such as a baseball cap, a backpack, or a beverage cup, prior to sale to resist theft of the object. The object is unlocked, by cutting the tie and removing the frangible element, and removed from the article after the sale. The object is returned and mounted back onto the article to a display position in which the object is displayed on the article. A platform supports the object upright on the article in the display position and, upon removal of the object, self-supports the object on a generally horizontal support surface remote from the article.

### CROSS REFERENCE TO RELATED APPLICATION

This application claims the benefit to U.S. Provisional Patent Application Ser. No. 61/572,581, filed Jul. 19, 2011, the entire contents of which are hereby incorporated herein by reference thereto.

### FIELD OF THE DISCLOSURE

The present disclosure relates generally to an article of manufacture having a three-dimensional object, such as a toy, a trophy, an ornament, a trinket or like novelty item or accessory, mounted thereon, preferably removably, and, more particularly, to a wearable article, such as a hat or cap, or a carrying article, such as a backpack, or any other article, such as a beverage cup with a lid, on which the object is initially secured and locked to the article to resist theft when offered for sale, is unlocked and removable from the article after the sale, and is mountable back on the article for display during wear, or carrying, or other use.

### BACKGROUND

A conventional baseball cap has a soft crown and a stiff brim or visor extending forwardly to shield a wearer's eyes from the sun. Although originally part of a professional baseball player's uniform, the baseball cap is often seen in everyday casual wear by people of all ages whether or not engaged in sports activities. The front of the crown typically contains designs or logos of sports teams, but virtually any graphics, artwork, or promotional or advertising information unrelated to sport teams can be displayed.

For enhanced use, a novelty item or accessory has been permanently incorporated in, or detachably mounted on, the cap. For example, flags bearing messages, miniature ornaments, clapping hand simulators, beer mugs, animal simulators, or like items have been clipped, snapped, magnetically attracted, or threadedly fastened onto the cap brim. If a child, for example, wanted to play with such a novelty item, then a permanently incorporated accessory could not be removed. A detachably mounted novelty item would be more easily removable and returnable for play purposes. However, if the novelty item were too easily removable, then it could be more readily removed and stolen in a retail store when offered for sale, and it could more easily fall off the cap during active wear. In addition, if the novelty item was too difficult to return to the cap for mounting thereon, then the novelty item would be more prone to not being returned, and being misplaced or lost.

Accordingly, there is a need for an article of manufacture in which a three-dimensional object, such as a toy or plaything, is reliably secured and locked to the article to resist theft when offered for sale, is easily unlocked and removed therefrom for play purposes, and is easily returned and mounted back on the article for display purposes and will not fall off the article during use.

### BRIEF DESCRIPTION OF THE FIGURES

The accompanying figures, where like reference numerals refer to identical or functionally similar elements throughout the separate views, together with the detailed description below, are incorporated in and form part of the specification, and serve to further illustrate embodiments of concepts that include the claimed invention, and explain various principles and advantages of those embodiments.

FIG. 1 is a perspective view of an arrangement including a cap, a three-dimensional object, and one embodiment of a support assembly for mounting the object on the cap in accordance with this invention;

FIG. 2 is an enlarged, exploded, broken-away, perspective view of the arrangement of FIG. 1;

FIG. 3 is an enlarged, sectional, broken-away view taken on line 3-3 of FIG. 1;

FIG. 4 is an exploded, perspective view of another arrangement including a cap, a three-dimensional object, and another embodiment of a support assembly for mounting the object on the cap in accordance with this invention;

FIG. 5 is a perspective view of yet another arrangement including a flat-brim cap, a three-dimensional object, and yet another embodiment of a support assembly for mounting the object on the cap in accordance with this invention;

FIG. 6 is an enlarged, exploded, part-broken-away, part-perspective view of the support assembly of FIG. 5;

FIG. 6A is an enlarged, plan view taken on line 6A-6A of FIG. 6;

FIG. 7 is an enlarged, sectional, broken-away view taken on line 7-7 of FIG. 5 in which the object is locked to the cap prior to sale;

FIG. 8 is a view analogous to FIG. 7 in an initial stage of unlocking the object from the cap after the sale;

FIG. 9 is a view analogous to FIG. 7 in a final stage of unlocking the object from the cap after the sale;

FIG. 10 is a view analogous to FIG. 7 in which the object is mounted and displayed on the cap during use;

FIG. 11 is a view analogous to FIG. 10 in which a decorative button is mounted on the cap;

FIG. 12 is a view analogous to FIG. 5, but of a curved-brim cap, a three-dimensional object, and a further embodiment of a support assembly for mounting the object on the cap in accordance with this invention;

FIG. 13 is an enlarged, sectional, broken-away view taken on line 13-13 of FIG. 12 in which the object is locked to the cap prior to sale;

FIG. 14 is a sectional, broken-away view of an additional embodiment of a support for mounting an object on a cap or backpack in accordance with this invention; and

FIG. 15 is a sectional, broken-away view of another embodiment of a support for mounting an object on a cap or backpack in accordance with this invention.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

The illustrated elements of the arrangement have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

### DETAILED DESCRIPTION

An arrangement, in accordance with one feature of this invention, comprises an article of manufacture having a mounting portion, a three-dimensional object, and a support for mounting the object on the mounting portion. Preferably, the support is a support assembly operative for mounting and locking the object on the mounting portion prior to sale of the arrangement, for unlocking and enabling removal of the object from the mounting portion after the sale, and for returning and mounting the object back onto the mounting portion to a display position in which the object is displayed on the article. Preferably, the object has a platform for supporting the object upright on the mounting portion in the display position and, upon removal of the object from the mounting portion, for self-supporting the object on a generally horizontal support surface remote from the arrangement. Advantageously, the object is a toy, a trophy, an ornament, a trinket or a like novelty item or accessory, that is played with and/or displayed and/or otherwise used, upon removal from the mounting portion. Advantageously, the article is a cap whose brim is the mounting portion, or a backpack having a panel that serves as the mounting portion, or a beverage cup having a lid that serves as the mounting portion. The object is preferably configured to relate in a common theme to a decoration on the cap, backpack, cup or like article.

In a preferred embodiment, the support assembly includes a fastener having a pin inserted in one longitudinal direction along a longitudinal axis into a recess, and turned in one circumferential direction about the longitudinal axis to mount the object on the mounting portion. The pin is turned in an opposite circumferential direction about the longitudinal axis, and is removed from the recess in an opposite longitudinal direction along the longitudinal axis to remove the object from the mounting portion. The fastener includes a projection connected to, and extending axially along the longitudinal axis away from, the object. The pin is connected to the projection and extends radially of the longitudinal axis. The fastener includes a coupler fixed to the article, and bounding a socket for receiving the projection. The coupler has a pair of interconnected, flanged tubular sleeves at opposite sides of the mounting portion, and the recess extends through one of the sleeves. The socket extends through the mounting portion and has opposite axial open end regions. The support assembly further includes a button mounted at one of the open end regions in the display position, and mounted at the opposite open end region when the object is removed from the mounting portion.

The support assembly also includes a frangible element extending from the object through and past the mounting portion to a remote end portion, and a tie at the remote end portion for securing the object on the article. The remote end portion has an aperture through which the tie extends prior to the sale. The tie is constituted of a cuttable material to release the object upon cutting of the tie.

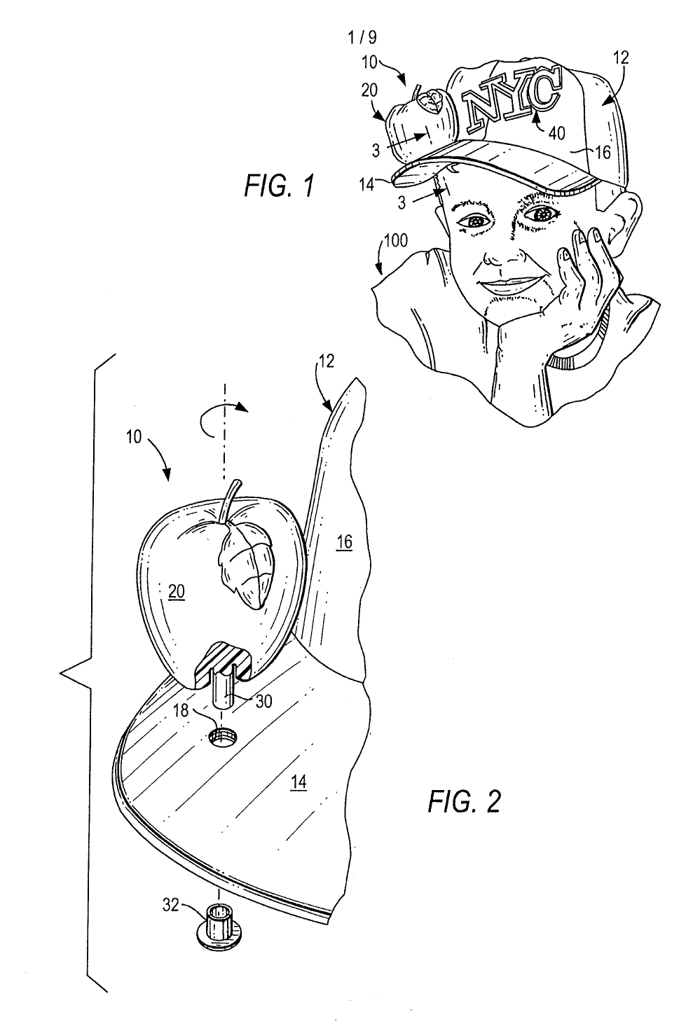

Turning now in detail to the drawings, reference numeral 10 in FIG. 1 generally identifies a novel arrangement, according to one embodiment of the present invention, comprising an article of manufacture, e.g., a cap 12, a three-dimensional object or decorative embellishment 20, and a support for mounting the object 20 on the cap 12. The cap 12 is a baseball cap having a soft crown portion 16, preferably constituted of a fabric material, for placement over a head of a wearer 100, and an outwardly extending brim or bill 14, preferably constituted of a stiff material, such as fabric-covered cardboard, that serves as a sun visor to shield the wearer's eyes. The brim 14 may be flat (see FIG. 5) or curved (see FIG. 12). The cap 12 may be custom-fitted to the wearer's head size, or it may have a rear adjuster so that it can be adjusted to fit the heads of different wearers. Indicia 40 is provided on the cap 12.

The three-dimensional object 20 can be configured as virtually any object, such as a toy, a trophy, an ornament, a trinket or a like novelty item or accessory, and can be constituted of virtually any material, such as molded plastic, foam, fabric, metal, aluminum, felt, plush, rubber, wood, cardboard, etc. As seen in FIG. 1, the three-dimensional object 20 is a replica of an apple. It is desirable that the indicia 40 imprinted on the cap 12 and the configuration of the object 20 relate to one another and form a common theme. For example, as seen in FIG. 1, the cap 12 is imprinted with the indicia 40 constituting the letters “NYC” promoting New York City, and the object 20 relates to an item generally associated with New York City, such as an apple.

While the object 20 is shown affixed to one side of the brim 14, offset from a center of the brim, the object 20 or multiple objects can be affixed at any location on the brim 14, including centrally. As seen best in FIG. 2, the brim 14 has at least one hole 18 provided therethrough, to allow the object 20 to be affixed to the brim 14. The hole 18 can be located in the center of the brim, or to either side of the brim, for placement of the object 20 at various locations on the brim. Moreover, more than one hole 18 can be provided to secure multiple three-dimensional objects to the brim or so that the wearer 100 can select where on the brim to affix the object 20.

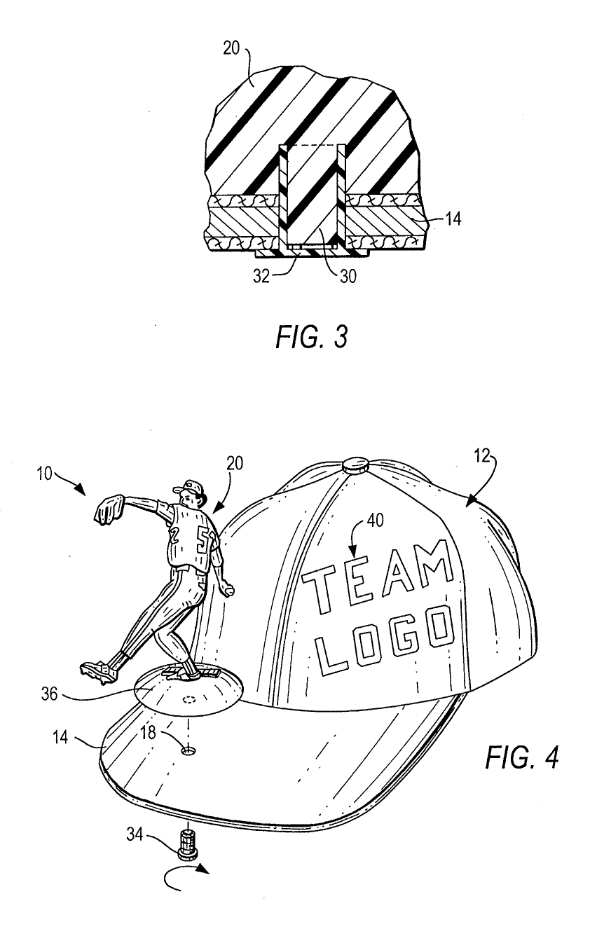

As seen in FIG. 2, the support includes a male fastener portion or projection 30 integral with, and extending along a longitudinal axis away from, the object 20. The projection 30 is removably insertable through the hole 18 in the brim 14 of the cap, so that the object 20 rests directly on top of the brim 14. A corresponding female fastener portion or flanged coupling nut 32 is inserted from beneath the brim 14 and has a socket for removably receiving the projection 30 with a friction-tight or press fit in order to hold the object 20 in place, as shown in FIG. 3.

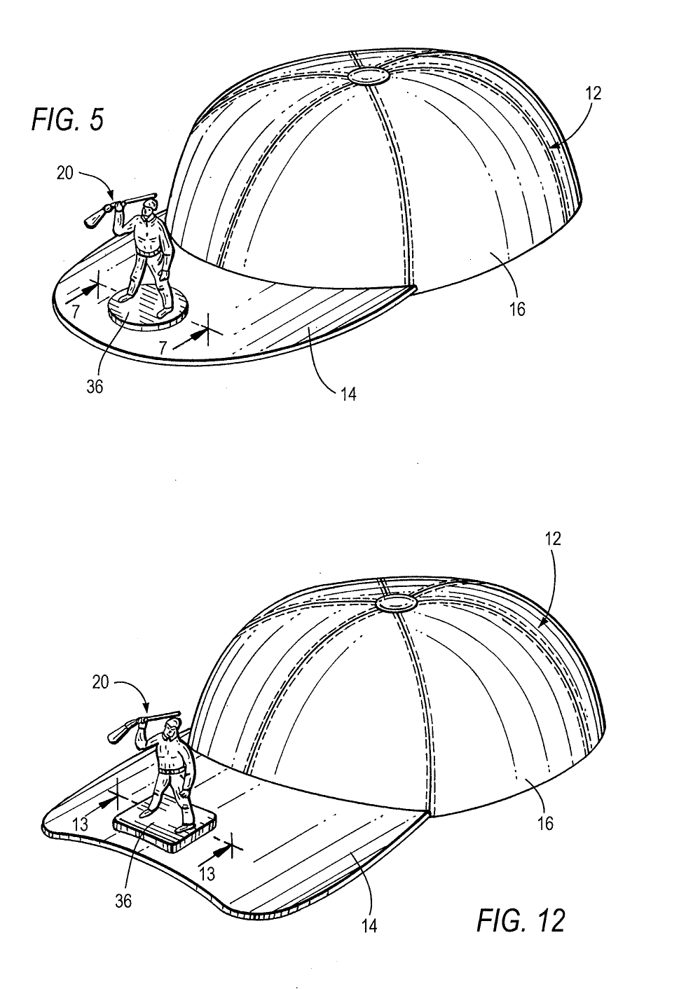

As seen best in FIG. 4, the object 20 is configured as an action figurine playing baseball, and is secured to the brim 14 via another support, e.g., a threaded male fastener 34, which is inserted from beneath the brim 14, through the hole 18, and into a corresponding threaded female recess (not shown) in a platform 36 that supports the object 20. In FIG. 4, the cap 12 is imprinted with the indicia 40 identifying a team logo, and the baseball-playing figurine configuration of the object 20 relates to that team and/or sport.

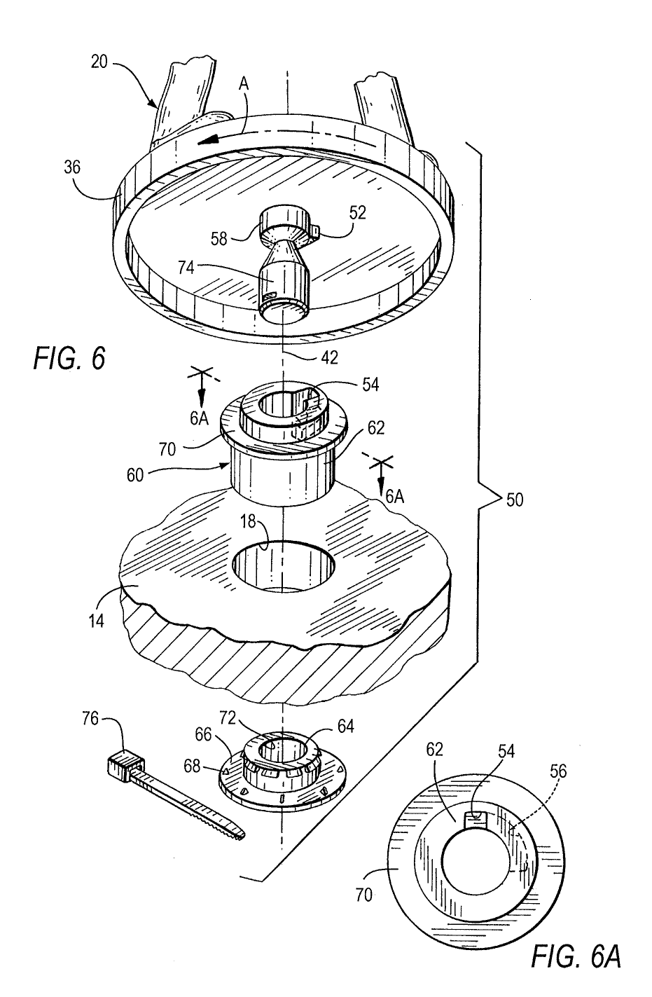

Turning now to the embodiment illustrated in FIGS. 5-11, like reference numerals have been employed to identify like parts of another arrangement that includes the cap 12 having the brim 14 that serves as a mounting portion, the three-dimensional object 20 (now configured as a toy soldier), and the support now configured as a support assembly 50, as best seen in FIGS. 6 and 6A, for mounting and locking the object 20 on the brim 14 prior to sale of the arrangement, for unlocking and enabling removal of the object 20 from the brim 14 after the sale, and for returning and mounting the object 20 back onto the brim 14 to a display position in which the object 20 is displayed on the cap 12. The platform 36 has a flat bottom for supporting the object 20 upright on the brim 14 in the display position shown in FIG. 5. Upon removal of the object 20 from the brim 14, as described below, the flat bottom of the platform 36 self-supports the object 20 on a generally horizontal support surface, e.g., a table top, a desk or the like, remote from the cap 12, where the object 20 can, for example, be played with and/or displayed and/or otherwise used.

The support assembly 50 includes a fastener having a center projection 58 connected to, and extending axially along a longitudinal axis 42 away from, the platform 36. A key or pin 52 is connected to the projection 58 and extends radially of the longitudinal axis 42. The pin 52 is inserted in one longitudinal direction along the longitudinal axis 42 into a keyslot or recess 54 formed in a coupler 60, and then turned in one circumferential direction in the direction of the arrow A about the longitudinal axis 42 along a curved track 56 (see FIG. 6A) to mount the object 20 on the brim 14. The pin 52 is turned in an opposite circumferential direction about the longitudinal axis 42 along the curved track 56, and removed from the recess 54 in an opposite longitudinal direction along the longitudinal axis 42 to remove the object 20 from the brim 14.

The coupler 60 includes a pair of interconnected, flanged, hollow, tubular sleeves 62, 64 inserted through opposite open axial ends of the brim hole 18 at opposite sides of the brim 14. The sleeve 64 has a flange 66, preferably with barbs 68, to bite into the bottom surface of the brim 14 and fix the sleeve 64 to the brim 14. The sleeve 62 also has a flange 70, preferably with barbs, to bite into on the upper surface of the brim 14 and fix the sleeve 64 to the brim 14. The sleeves 62, 64 bound an internal cylindrical socket 72 for receiving the projection 58.

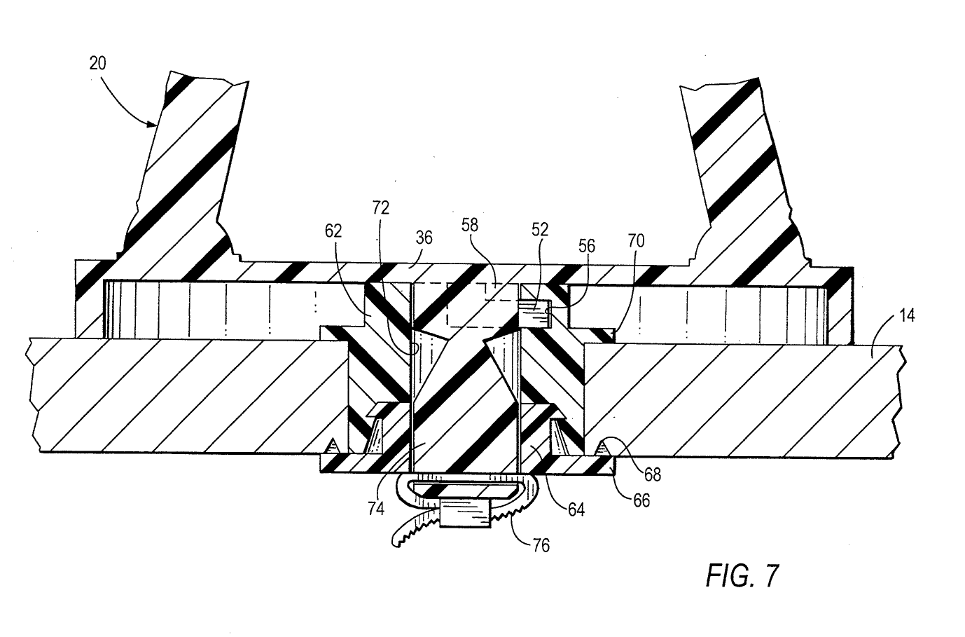

The support assembly further includes a frangible element 74 extending from the projection 58 along the longitudinal axis 42 through the socket 72 and past the brim 14 to a remote apertured end portion (see FIG. 7), and an elongated tie 76, conventionally known as a zip tie, passing through the remote apertured end portion for securing the object 20 on the brim 14. In FIG. 7, the object is locked on the brim 14 by the tie 76, thereby resisting theft prior to sale.

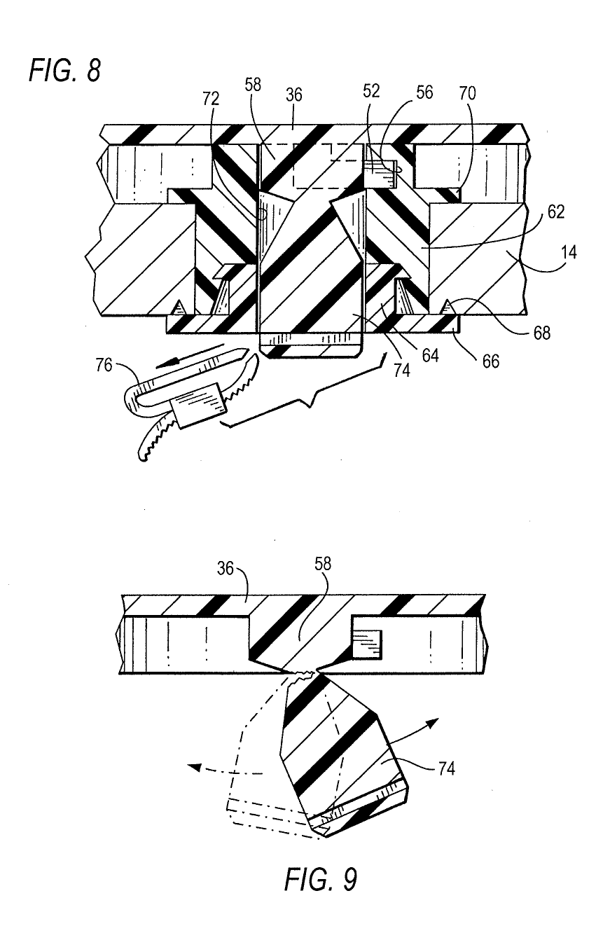

FIGS. 8-9 depict how the object is unlocked after the sale. The tie 76 is constituted of a cuttable material, e.g., plastic, to release the object 20 upon cutting of the tie 76, as shown in FIG. 8. Then, the object is removed from the cap, and the frangible element 74 is rocked back-and-forth, as shown in FIG. 9, until the frangible element 74 is severed and removed from the projection 58.

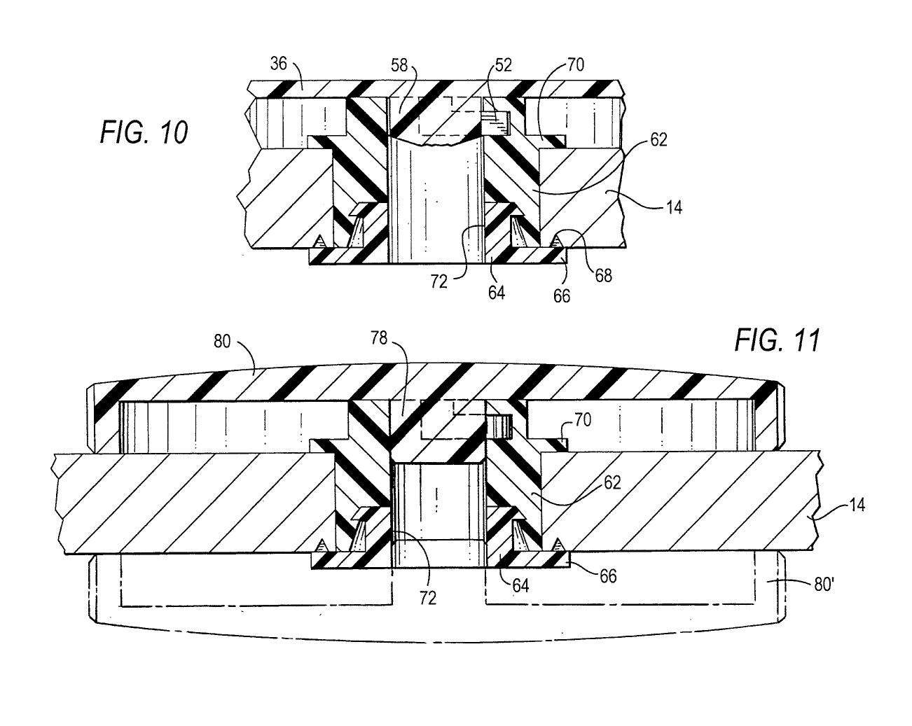

The object can now be removed and returned back onto the brim, as shown in FIG. 10. As before, the pin 52 is inserted in one longitudinal direction along the longitudinal axis 42 into the recess 54, and then turned in one circumferential direction in the direction of the arrow A about the longitudinal axis 42 along the track 56 to securely mount the object 20 on the brim 14. As before, the pin 52 is turned in the opposite circumferential direction about the longitudinal axis 42 along the track 56, and removed from the recess 54 in the opposite longitudinal direction along the longitudinal axis 42 to remove the object 20 from the brim 14. The object 20 can thus be displayed on the cap, or removed and used remotely from the cap, as desired.

When the object 20 is remote from the cap 12, the fastener 60 is visible. Another feature of this invention is directed to concealing the fastener 60 under such circumstances. This is achieved by covering the fastener 60 with a button 80 (see FIG. 11) having a center post 78 mounted, preferably with s friction fit, in one of the open end regions of the socket 72. As shown by solid lines in FIG. 11, when the object is removed from the brim 14, the button 80 conceals the fastener 60 when its post 78 is mounted in the upper end of the socket 72. Otherwise, when the object is mounted on the brim 14 in the display position, the post 78 can be inserted in the lower end of the socket 72, as shown by phantom lines 80′.

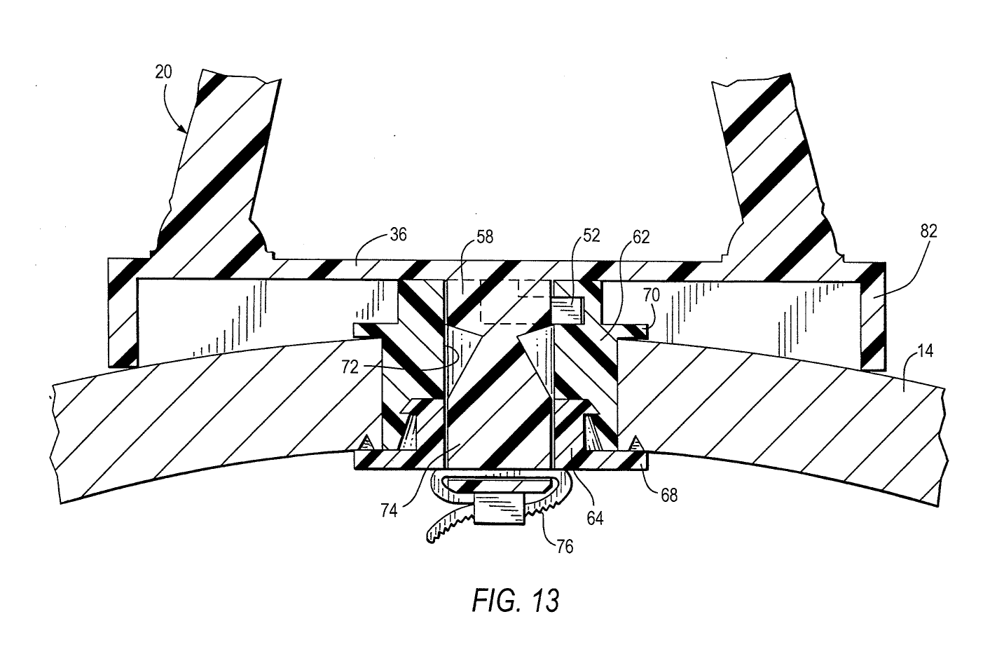

As mentioned above, FIG. 12 depicts a curved-brim cap, and FIG. 13 depicts how the platform 36 is modified to conform to the curvature of the brim, essentially by extending the outer side wall 82 of the platform.

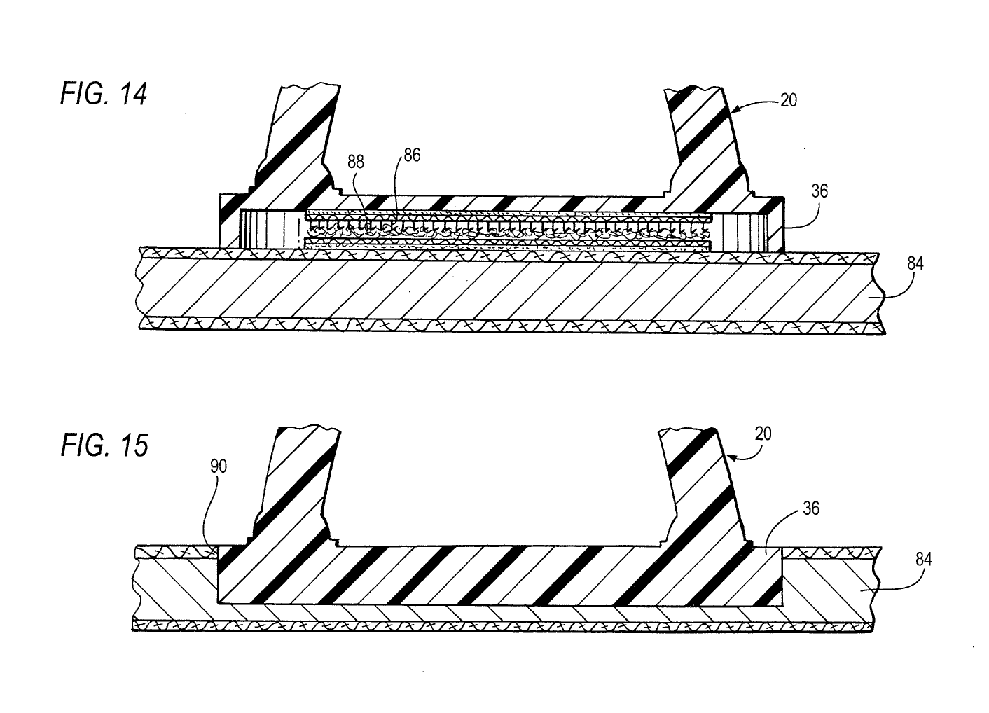

According to other embodiments of the present invention, the support for mounting the object 20 on the article can be configured by such other support means as, for example, clips, magnets, hook-and-loop fasteners, or repositionable or permanent adhesives, or stitching. Thus, as shown in FIGS. 14-15, an article of manufacture 84 can be the aforementioned cap, or backpack, or cup, etc. The article 84 can be fabric-covered as illustrated, or not. The object 20 is mounted, either permanently or removably, by any of the aforementioned support means. Hook fastener 86 is secured to the underside of the object 20, and the complementary loop fastener 88 is secured to the top of the article 84. In FIG. 14, the platform 36 of the object 20 rests on an upper surface of the article, whereas, in FIG. 15, the platform 36 of the object 20 fits, preferably with a friction-fit, inside a well 90 formed in the article 84 such that an upper surface of the platform 36 lies in a common plane with the upper surface of the article 84.

In accordance with another feature of this invention, a method is performed by mounting and locking a three-dimensional object 20 on a mounting portion of an article of manufacture 12 prior to sale, unlocking and enabling removal of the object 20 from the mounting portion after the sale, and returning and mounting the object 20 back onto the mounting portion to a display position in which the object 20 is displayed on the article 12.

In the foregoing specification, specific embodiments have been described. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of present teachings.

For example, although FIGS. 1-13 of the drawings depict the article of manufacture 12 as being a baseball cap, this was done strictly for convenience since the article 12 can be any article worn, or carried, or handled by a user. Thus, as illustrated in FIGS. 14-15, the article 84 can be a backpack, in which case, the object 20 is mounted thereon, preferably at an upper panel (or mounting portion) at which the object 20 is readily visible. As another example, the article can be a beverage cup having a lid (or mounting portion), in which case, the object 20 is mounted on the lid.

The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

Moreover in this document, relational terms such as first and second, top and bottom, and the like may be used solely to distinguish one entity or action from another entity or action without necessarily requiring or implying any actual such relationship or order between such entities or actions. The terms “comprises,” “comprising,” “has,” “having,” “includes,” “including,” “contains,” “containing,” or any other variation thereof, are intended to cover a non-exclusive inclusion, such that a process, method, article, or apparatus that comprises, has, includes, contains a list of elements does not include only those elements, but may include other elements not expressly listed or inherent to such process, method, article, or apparatus. An element proceeded by “comprises . . . a,” “has . . . a,” “includes . . . a,” or “contains . . . a,” does not, without more constraints, preclude the existence of additional identical elements in the process, method, article, or apparatus that comprises, has, includes, or contains the element. The terms “a” and “an” are defined as one or more unless explicitly stated otherwise herein. The terms “substantially,” “essentially,” “approximately,” “about,” or any other version thereof, are defined as being close to as understood by one of ordinary skill in the art, and in one non-limiting embodiment the term is defined to be within 10%, in another embodiment within 5%, in another embodiment within 1%, and in another embodiment within 0.5%. The term “coupled” as used herein is defined as connected, although not necessarily directly and not necessarily mechanically. A device or structure that is “configured” in a certain way is configured in at least that way, but may also be configured in ways that are not listed.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus, the following claims are hereby incorporated into the Detailed Description, with each claim standing on its own as a separately claimed subject matter.

We claim:

1. An arrangement comprising:
an article of manufacture having a mounting portion;
a three-dimensional object; and
a support for mounting the object on the mounting portion.

2. The arrangement of claim 1, wherein the support includes a support assembly for mounting and locking the object on the mounting portion prior to sale of the arrangement, for unlocking and enabling removal of the object from the mounting portion after the sale, and for returning and mounting the object back onto the mounting portion to a display position in which the object is displayed on the article.

3. The arrangement of claim 2, wherein the object has a platform for supporting the object upright on the mounting portion in the display position and, upon removal of the object from the mounting portion, for self-supporting the object on a generally horizontal support surface remote from the arrangement.

4. The arrangement of claim 1, wherein the article is a cap having a brim and a decoration thereon, wherein the mounting portion is the brim, and wherein the object is configured to relate in a common theme to the decoration on the cap.

5. The arrangement of claim 2, wherein the support assembly includes a fastener having a pin inserted in one longitudinal direction along a longitudinal axis into a recess, and turned in one circumferential direction about the longitudinal axis to mount the object on the mounting portion; and wherein the pin is turned in an opposite circumferential direction about the longitudinal axis, and removed from the recess in an opposite longitudinal direction along the longitudinal axis to remove the object from the mounting portion.

6. The arrangement of claim 5, wherein the fastener includes a projection connected to, and extending axially along the longitudinal axis away from, the object; and wherein the pin is connected to the projection and extends radially of the longitudinal axis.

7. The arrangement of claim 6, wherein the fastener includes a coupler fixed to the article, and bounding a socket for receiving the projection.

8. The arrangement of claim 7, wherein the coupler has a pair of interconnected, flanged tubular sleeves at opposite sides of the mounting portion, and wherein the recess extends through one of the sleeves.

9. The arrangement of claim 7, wherein the socket extends through the mounting portion and has opposite axial open end regions; and wherein the support assembly includes a button mounted at one of the open end regions in the display position, and mounted at the opposite open end region when the object is removed from the mounting portion.

10. The arrangement of claim 2, wherein the support assembly includes a frangible element extending from the object through and past the mounting portion to a remote end portion, and a tie at the remote end portion for securing the object on the article.

11. The arrangement of claim 10, wherein the tie is constituted of a cuttable material to release the object upon cutting of the tie.

12. The arrangement of claim 1, wherein the support is one of an adhesive, a magnet, a hook-and-loop fastener, a clip, and stitching.

13. An arrangement comprising:
an article of manufacture having a mounting portion;
a three-dimensional object; and
a support assembly for mounting and locking the object on the mounting portion prior to sale of the arrangement, for unlocking and enabling removal of the object from the mounting portion after the sale, and for returning and mounting the object back onto the mounting portion to a display position in which the object is displayed on the article.

14. The arrangement of claim 13, wherein the article is a cap having a crown portion and a brim portion constituting the mounting portion and extending away from the crown portion.

15. The arrangement of claim 13, wherein the article is a backpack having a panel constituting the mounting portion.

16. The arrangement of claim 13, wherein the support assembly includes a frangible element extending from the object through and past the mounting portion to a remote end portion, and a tie at the remote end portion for securing the object on the article; and wherein the tie is constituted of a cuttable material to release the object upon cutting of the tie.

17. An arrangement comprising:
an article of manufacture having a mounting portion;
a three-dimensional object; and
a support assembly including a frangible element extending from the object through and past the mounting portion to a remote end portion, and a cuttable tie at the remote end portion for mounting and locking the object on the mounting portion prior to sale of the arrangement, the support assembly being operative for unlocking and enabling removal of the object from the mounting portion after the sale by cutting the tie and removing the frangible element, and for returning and mounting the object back onto the mounting portion to a display position in which the object is displayed on the article.

18. The arrangement of claim 17, wherein the remote end portion has an aperture through which the tie extends prior to the sale.

19. The arrangement of claim 17, wherein the support assembly includes a fastener having a pin inserted in one longitudinal direction along a longitudinal axis into a recess, and turned in one circumferential direction about the longitudinal axis to mount the object on the mounting portion; and wherein the pin is turned in an opposite circumferential direction about the longitudinal axis, and removed from the recess in an opposite longitudinal direction along the longitudinal axis to remove the object from the mounting portion.

20. The arrangement of claim 17, wherein the article is one of a cap, a cup and a backpack.
